(19) United States
(12) Patent Application Publication
(10) Pub. No.: US 2008/0170102 A1
(43) Pub. Date: Jul. 17, 2008

(54) INKJET PRINT HEAD CHIP, METHOD FOR MANUFACTURING AN INKJET PRINT HEAD CHIP, STRUCTURE FOR CONNECTING AN INKJET PRINT HEAD CHIP AND A FLEXIBLE PRINTED CIRCUIT BOARD, AND METHOD FOR CONNECTING AN INKJET PRINT HEAD CHIP AND A FLEXIBLE PRINTED CIRCUIT BOARD

(75) Inventors: Jung-wook KIM, Yongin-si (KR); Seo-hyun Cho, Seongnam-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/838,443

(22) Filed: Aug. 14, 2007

(30) Foreign Application Priority Data
Jan. 12, 2007 (KR) 2007-3920

(51) Int. Cl. B41J 2/145

(52) U.S. Cl. 347/50

(57) ABSTRACT

An inkjet print head chip capable of preventing an adhesive from flowing over a nozzle part during a connection work of a flexible printed circuit board thereto is provided with a nozzle part to have a plurality of nozzles formed therein; a plurality of connecting pads disposed at a side of the nozzle part and electrically connected to a plurality of ink firing portions formed under the nozzle part; and an overflow prevention dam disposed between the nozzle part and the plurality of connecting pads and to have a height higher than the plurality of connecting pads.

### CROSS-REFERENCE TO RELATED APPLICATION

This application claims all benefits accruing under 35 U.S.C. § 119 from Korean Patent Application No. 2007-3920 filed on Jan. 12, 2007 in the Korean Intellectual Property Office, the disclosure of which is incorporated herein by reference.

### BACKGROUND OF THE INVENTION

1. Field of the Invention

This present invention relates to an inkjet print head chip, a manufacturing method for the inkjet print head chip, a connecting structure for an inkjet print head chip and a flexible printed circuit board, a connecting method for the inkjet print head chip and the flexible printed circuit board.

2. Related Art

Generally, an inkjet print head has an inkjet print head chip provided on a bottom surface thereof. The inkjet print head chip is provided with a plurality of ink firing portions and is electrically connected with a flexible printed circuit board (PCB) to receive electrical signals and supply a current thereto. When the electrical signals and the current are received from the flexible printed circuit board (PCB), the ink firing portions of the inkjet print head chip activate and fire extremely small droplets of ink onto a printing medium, such as paper, to form a predetermined image.

FIGS. 1A and 1B illustrate a typical method for connecting a flexible printed circuit board (PCB) to an inkjet print head chip disposed on an inkjet print head. Referring to FIGS. 1A and 1B, an inkjet print head chip 10 disposed on an inkjet print head 1 has a plurality of connecting pads 12 to be connected to a plurality of lead wires 22 of the flexible printed circuit board (PCB) 20. The plurality of connecting pads 12 is electrically connected to a plurality of ink firing portions (not illustrated) formed inside the inkjet print head chip 10. Each ink firing portion has a heating means used to heat ink so as to allow the ink to be fired through a nozzle of the ink firing portion. Therefore, electrical signals and a current transmitted through the flexible printed circuit board (PCB) 20 are used to control the heating means of each of the ink firing portions to fire ink.

Hereinafter, a method for connecting the flexible printed circuit board (PCB) 20 to the inkjet print head chip 10 disposed on the inkjet print head 1 will be explained as follows.

First, as illustrated in FIG. 1A, the plurality of exposed lead wires 22 of the flexible printed circuit board (PCB) 20 is precisely aligned on the plurality of connecting pads 12 of the inkjet print head chip 10. Next, a bonding apparatus 3 is used to press the lead wires 22 of the flexible printed circuit board (PCB) 20 against the connecting pads 12 at a predetermined temperature and pressure for a predetermined time so that the lead wires 22 of the flexible printed circuit board (PCB) 20 are bonded to the connecting pads 12. After that, a protection agent 30 is coated on the lead wires 22 of the flexible printed circuit board (PCB) 20 to complete the connection.

At this time, a tape automated bonding method (hereinafter, referred to “TAB” method) is widely used to bond the lead wires 22 of the flexible printed circuit board (PCB) 20 to the connecting pads 12 of the inkjet print head chip 10. The TAB method applies a predetermined temperature and pressure for a predetermined time using an inner lead bonding (hereinafter, referred to “ILB”) tool so as to bond the lead wires 22 of the flexible printed circuit board (PCB) 20 to the connecting pads 12 of the inkjet print head chip 10.

The ILB tool may use an ultra-sonic wave to heat. Alternatively, the ILB tool may use a tool tip as an electrode to cause the tool tip to be heated by itself. Since a lot of heat is used to apply to a small area for a short time period, for example, less than a second, a reliable and fine bonding can be accomplished. However, there is a problem that heat cannot be uniformly applied to an object with a large area. Therefore, when using the TAB method, it is difficult to connect all the lead wires 22 of the flexible printed circuit board 20 to the connecting pads 12 of the inkjet print head chip 10 at once, and, in view of such a difficulty, the lead wires 22 need to be bonded to the connecting pads 12 on a one-by-one basis. As a result, there is a problem that the TAB method takes a lot of time to connect the flexible printed circuit board (PCB) 20 to the inkjet print head chip 10.

To solve the above problems, a liquid adhesive, such as an anisotropic conductive paste (ACP) or a non conductive paste (NCP), has been considered and used to bond the lead wires 22 of the flexible printed circuit board (PCB) 20 to the connecting pads 12 of the inkjet print head chip 10. In other words, the liquid adhesive can be coated on the connecting pads 12, and then the lead wires 22 of the flexible printed circuit board (PCB) 20 can be set thereon, and then the lead wires 22 can be pressed by the bonding apparatus 3 so that the connecting pads 12 and the lead wires 22 are bonded.

However, the liquid adhesive, such as ACP or NCP, has a certain level of fluidity. As a result, even if the amount of the liquid adhesive is precisely measured and is then coated on the connecting pads 12, the liquid adhesive between the connecting pads 12 and the lead wires 22 is pushed or squeezed out from the connecting pads 12, when the lead wires 22 of the flexible printed circuit board (PCB) 20 are pressed against the inkjet print head chip 10 due to the fluidity of liquid substance. When squeezed out from the connecting pads 12 of the inkjet print head chip 10, such a liquid adhesive may block or contaminate nozzles of the ink firing portions of the inkjet print head chip 10.

### SUMMARY OF THE INVENTION

Several aspects and example embodiments of the present invention provide an inkjet print head chip, a manufacturing method for an inkjet print head chip, a connecting structure for an inkjet print head chip and a flexible printed circuit board (PCB), and a connecting method for an inkjet print head chip and a flexible printed circuit board (PCB) capable of connecting at once a plurality of lead wires of the flexible printed circuit board (PCB) to a plurality of connecting pads of the inkjet print head chip without the contamination of nozzles.

Additional aspects and/or advantages of the invention will be set forth in part in the description which follows and, in part, will be obvious from the description, or may be learned by practice of the invention.

In accordance with an example embodiment of the present invention, an inkjet print head chip is provided with a nozzle part having a plurality of nozzles formed therein; a plurality of connecting pads disposed at a side of the nozzle part and electrically connected to a plurality of ink firing portions formed in the nozzle part; and an overflow prevention dam disposed between the nozzle part and the plurality of connecting pads and to have a height higher than the plurality of connecting pads.

According to an aspect of the present invention, the height of the overflow prevention dam may be substantially equal to a height of the nozzle part.

According to another aspect of the present invention, the inkjet print head chip may further comprise a gully formed between the nozzle part and the overflow prevention dam.

According another aspect of the present invention, the inkjet print head chip may further include one or more lead protection dams formed at a side of the plurality of connecting pads opposite to the overflow prevention dam, each of the lead protection dams has a size corresponding to that of each of the plurality of connecting pads.

In accordance with another example of the present invention, a method for manufacturing an inkjet print head chip comprises forming a base substrate having a nozzle part in which electrical circuits to fire ink according to an electrical signal are formed and an electrical connecting part on which a metal pad is exposed thereon for electrical connection to the outside; forming a gold (Au) layer on the metal pad; forming an adhesive layer; forming an ink chamber, a lower part of an overflow prevention dam, and a lead protection dam using a photo masking process; and forming a plurality of nozzles and an upper part of the overflow prevention dam using another photo masking process.

According to an aspect of the present invention, the ink chamber, the lower part of the overflow prevention dam, and the lead protection dam may be formed using an epoxy type photo-resist.

In accordance with another example embodiment of the present invention, a structure for connecting a flexible printed circuit board (PCB) to an inkjet print head chip may include: an inkjet print head chip comprising a nozzle part having a plurality of ink firing portions arranged to fire droplets of ink, via corresponding nozzles respectively, onto a printable medium to form an image; a plurality of connecting pads disposed at a side of the nozzle part and electrically connected to the plurality of ink firing portions formed in the nozzle part; and an overflow prevention dam disposed between the nozzle part and the plurality of connecting pads and to have a height higher than the plurality of connecting pads, wherein the flexible printed circuit board (PCB) is provided with a plurality of lead wires corresponding to the plurality of connecting pads one by one; and an adhesive is provided to bond the plurality of lead wires to the plurality of connecting pads.

According to an aspect of the invention, the adhesive may use an anisotropic conductive paste (ACP), a non-conductive paste (NCP), or an anisotropic conductive film (ACF).

According to another aspect of the present invention, a method for connecting a flexible printed circuit board (PCB) to an inkjet print head chip having a plurality of connecting pads comprises: coating an adhesive on the plurality of connecting pads of the inkjet print head chip; positioning the flexible printed circuit board (PCB) so that a plurality of lead wires disposed on the flexible printed circuit board (PCB) is aligned with the plurality of connecting pads of the inkjet print head chip on a one-by-one basis; pressing the plurality of lead wires of the flexible printed circuit board (PCB) against the plurality of connecting pads of the inkjet print head chip at once using a bonding apparatus; causing an overflow prevention dam disposed on the inkjet print head chip to block the adhesive pushed out from between the plurality of lead wires and connecting pads; and separating the bonding apparatus from the plurality of lead wires.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIGS. 1A and 1B are a sectional view illustrating a process for connecting a conventional inkjet print head chip and a flexible printed circuit board (PCB);

FIG. 2 is a plan view illustrating an inkjet print head chip disposed at an inkjet print head according to an example embodiment of the present invention;

FIG. 3 is a sectional view illustrating the inkjet print head chip taken along a line III-III, as shown in FIG. 2;

FIG. 4 is a plan view illustrating a liquid adhesive coated on a plurality of connecting pads of the inkjet print head chip shown in FIG. 2;

FIG. 5 is a plan view illustrating a flexible printed circuit board (PCB) bonded on the inkjet print head chip shown in FIG. 4;

FIG. 6 is a side view illustrating a protection agent coated on the lead wires of the flexible printed circuit board (PCB) bonded on the inkjet print head chip shown in FIG. 5; and

FIG. 7 is a flow chart illustrating a method for manufacturing an inkjet print head chip according to an example embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Hereinafter, an inkjet print head chip, a manufacturing method for an inkjet print head chip, a connecting structure for an inkjet print head chip and a flexible printed circuit board (PCB), and a connecting method for an inkjet print head chip and a flexible printed circuit board (PCB) according to an example embodiment of the present invention will be described in detail with reference to the accompanying drawings.

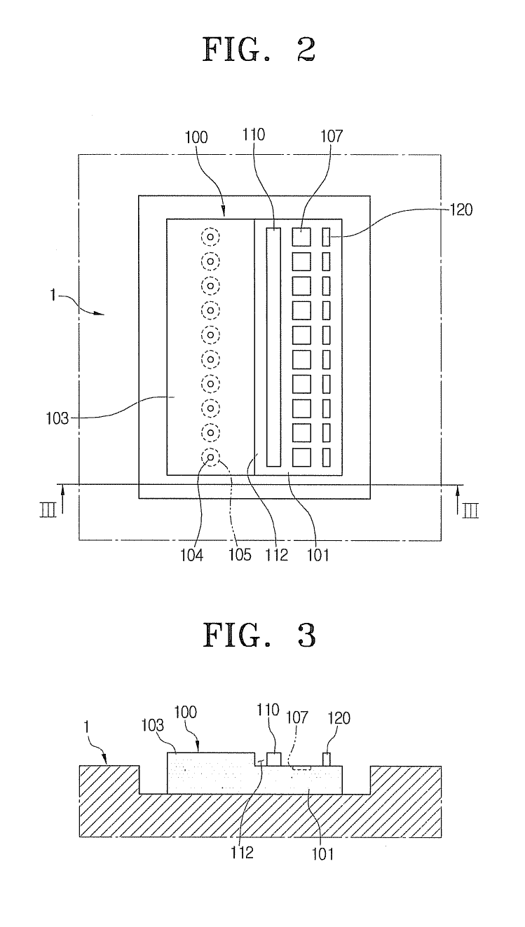

FIG. 2 is a plan view illustrating a part of an inkjet print head at which an inkjet print head chip is disposed according to an example embodiment of the present invention, and FIG. 3 is a sectional view illustrating the inkjet print head chip taken along a line III-III, as shown in FIG. 2. FIG. 3 does not show an inner structure of the inkjet print head that is not related with the present invention and that is similar to a conventional inkjet print head.

Referring to FIGS. 2 and 3, an inkjet print head chip 100 includes a base 101, a nozzle part 103, a plurality of connecting pads 107, an overflow prevention dam 110, and a lead protection dam 120.

The base 101 forms a body of the inkjet print head chip 100 and is fixed at an inkjet print head 1. The nozzle part 103 is formed at a side of the base 101. Under the nozzle part 103, that is, inside the base 101 is formed a plurality of ink firing portions 105 that fire a small amount of ink according to an electrical signal and a current input, via a flexible printed circuit board (PCB) 20.

In the nozzle part 103 is formed in a line a plurality of nozzles 104 to fluidly communicate with the plurality of ink firing portions 105. FIG. 2 illustrates the nozzle part 103 where the plurality of nozzles 104 is formed in a line; however, the nozzles 104 can be arranged differently. For example, the nozzles 104 may be formed in more than two lines at the nozzle part 103. The nozzle part 103 may be formed to have the substantially same height as that of a top surface of the base 101. Alternatively, the nozzle part 103 may be formed to have a height higher than that of the top surface of the base 101.

The plurality of connecting pads 107 is electrically connected to the plurality of ink firing portions 105, via the inside of the base 101. The plurality of connecting pads 107 is formed in parallel to the plurality of nozzles 104 at an edge of the top surface of the base 101, and has the number corresponding to the number of the ink firing portions 105. The plurality of connecting pads 107 is made of a metal with a high conduction, for example, gold (Au). Therefore, electrical signals and a current input from the flexible printed circuit board (PCB) 20 bonded on the plurality of connecting pads 107 are transmitted to the ink firing portions 105, via the connecting pads 107.

The overflow prevention dam 110 is formed in a protrusion shape to project from the top surface of the base 101, and is disposed between the nozzle part 103 and the plurality of connecting pads 107. According to an example embodiment of the present invention, the overflow prevention dam 110 is formed in a long slim rectangular bar shape. At this time, the overflow prevention dam 110 is spaced apart from the nozzle part 103 and the plurality of connecting pads 107. Therefore, a gully 112 is formed between the overflow prevention dam 110 and the nozzle part 103. A height of the overflow prevention dam 110 is determined so that, when the plurality of lead wires 22 of the flexible printed circuit board (PCB) 20 is pressed against the plurality of connecting pads 107 of the inkjet print head chip 100, an outflow liquid adhesive cannot flow over the overflow prevention dam 110 considering the amount of the liquid adhesive required to bond at once all the plurality of lead wires 22 of the flexible printed circuit board (PCB) 20 to the plurality of connecting pads 107. Therefore, the overflow prevention dam 110 may have a height substantially equal to or lower than a height of the nozzle part 103.

The overflow prevention dam 110 prevents a liquid adhesive pushed or squeezed out between the plurality of lead wires 22 and connecting pads 107 from flowing into the nozzle portion 103, when the liquid adhesive is coated on the plurality of connecting pads 107 and then all the lead wires 22 of the flexible printed circuit board (PCB) 20 are pressed at once. In addition, if the liquid adhesive is coated too much on the connecting pads 107 of the inkjet print head chip 100 or has a high level of fluidity, and when such a liquid adhesive is pushed or squeezed out from the connecting pads 107 and the lead wires 22 and flows over the overflow prevention dam 110, the overflowed liquid adhesive flows into and piles up in the gully 112 formed between the nozzle part 103 and the overflow prevention dam 110.

The lead protection dam 120 prevents the plurality of lead wires 22 of the flexible printed circuit board (PCB) 20 from being damaged by an edge of the inkjet print head chip 100. The lead protection dam 120 is formed at a side of the plurality of connecting pads 107 opposite to the overflow prevention dam 110. In other words, the lead protection dam 120 is formed in a protrusion shape to project from the top surface of the base 101 between the plurality of connecting pads 107 and the edge of the base 101. The lead protection dam 120 may be formed in a long slim rectangular bar shape similar to the above-described overflow prevention dam 110. In other words, the lead protection dam 120 may be formed in a single piece. However, in the example embodiment shown in FIG. 2, the lead protection dam 120 can be formed in many pieces with a size corresponding to a size of each of the plurality of connecting pads 107. A height of the lead protection dam 120 may be equal to or less than the height of the overflow prevention dam 110.

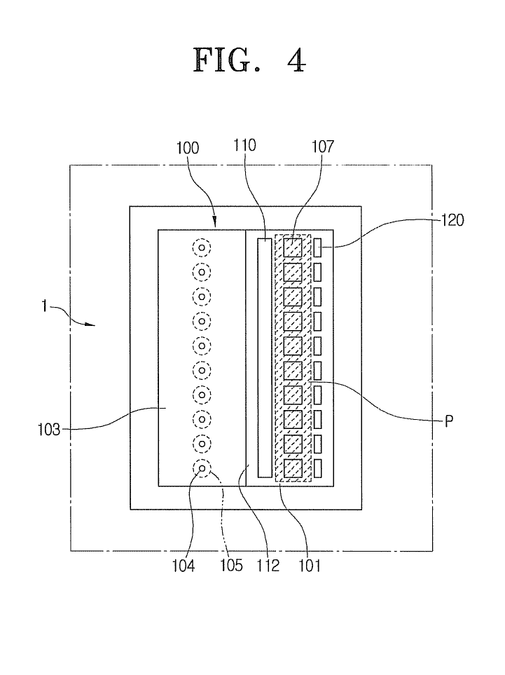

Hereinafter, a method for connecting the flexible printed circuit board 20 to the inkjet print head chip 100 will be explained with reference to FIGS. 4 to 6.

First, a liquid adhesive is coated on the plurality of connecting pads 107 of the inkjet print head chip 100 disposed on the inkjet print head 1. In other words, as illustrated in FIG. 4, a proper amount of the liquid adhesive P is coated on the plurality of connecting pads 107 between the overflow prevention dam 110 and the lead protection dam 120. At this time, the liquid adhesive P may use an anisotropic conductive paste (ACP) or a non-conductive paste (NCP).

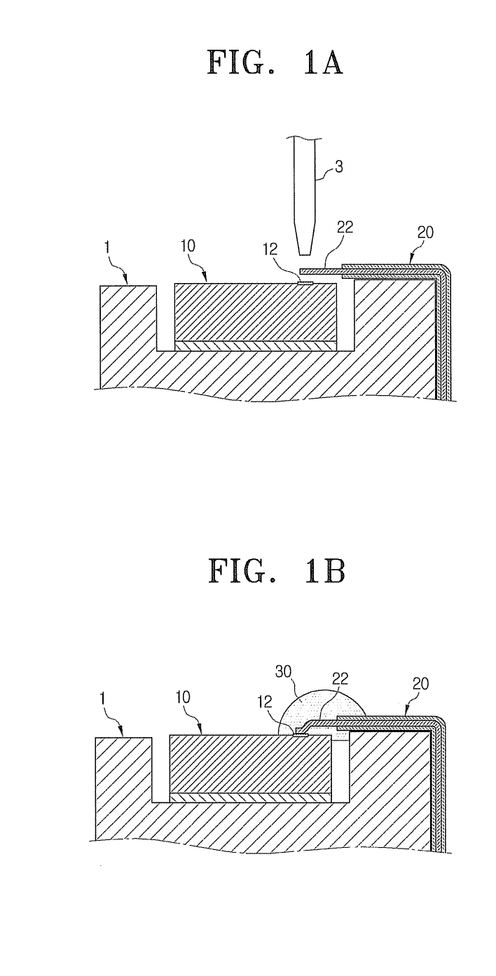

Subsequently, the flexible printed circuit board (PCB) 20 is positioned so that each of the plurality of exposed lead wires 22 is aligned with each of the plurality of connecting pads 107 of the inkjet print head chip 100. After that, the plurality of lead wires 22 is pressed at a predetermined pressure and temperature for a predetermined time by a bonding apparatus (not shown in FIG. 2 and FIG. 3, but shown in FIG. 1) that can press at once the plurality of lead wires 22 against the plurality of connecting pads 107. At this time, conditions such as time, pressure, and temperature in which the bonding apparatus (not shown) presses the plurality of lead wires 22 are determined according to the property of the liquid adhesive P and a performance of the bonding apparatus.

When the bonding apparatus (not shown) presses the plurality of lead wires 22 against the plurality of connecting pads 107, the liquid adhesive P between the plurality of connecting pads 107 and lead wires 22 is pushed out all around. Some liquid adhesive P that is pushed out from between the plurality of connecting pads 107 and lead wires 22 and then flows toward the nozzle part 103 is blocked by the overflow prevention dam 110, thereby not reaching the nozzle part 103. If the liquid adhesive P flows over the overflow prevention dam 110 due to too much coating or a lower viscosity of the liquid adhesive P, the overflowed liquid adhesive P flows down and piles up in the gully 112 between the overflow prevention dam 110 and the nozzle part 103. As a result, the outflow of the liquid adhesive P caused by the connection of the plurality of lead wires 22 and connecting pads 107 is prevented from contaminating or blocking the nozzle part 103.

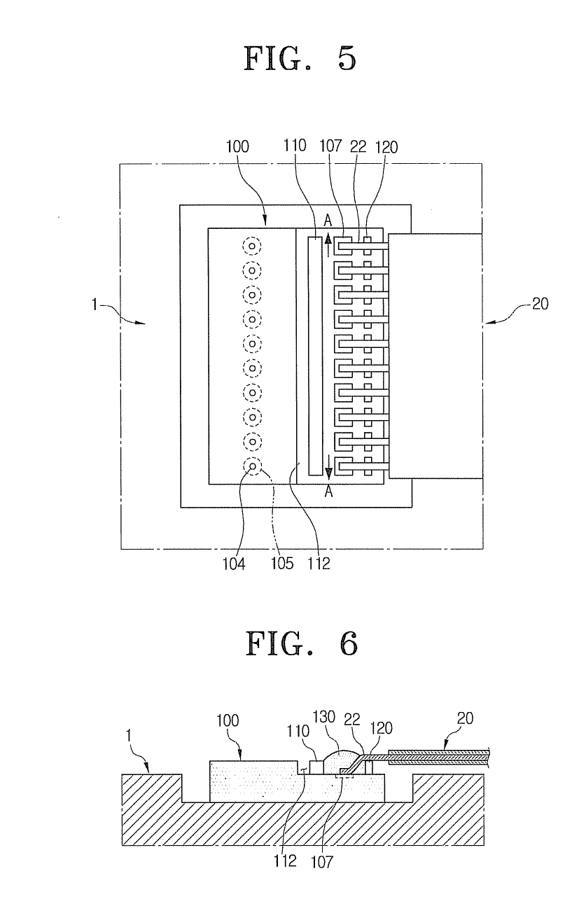

On the other hand, the liquid adhesive P to flow toward the lead protection dams 120 is mainly blocked by the plurality of lead protection dams 120 and partly flows between the plurality of lead protection dams 120. Also, liquid adhesive P to flow toward an upper side and a lower side of a space between the overflow prevention dam 110 and the lead protection dams 120 as arrows A illustrated in FIG. 5 flows out the edges of the base 101 of the inkjet print head chip 100. However, the liquid adhesive P flowed out the edges of the inkjet print head chip 100 besides the nozzle part 103 does not damage a performance of the inkjet print head chip 100.

After a predetermined time, the bonding apparatus is separated from the plurality of lead wires 22. Then, a protection agent 130 is coated on the plurality of lead wires 22 so that the connection of the inkjet print head chip 100 and the flexible printed circuit board (PCB) 20 is completed.

With the method and structure for connecting the flexible printed circuit board 20 and the inkjet print head chip 100 according to an example embodiment of the present invention, when the plurality of lead wires 22 of the flexible printed circuit board 20 is connected to the plurality of connecting pads 107 of the inkjet print head chip 100, the liquid adhesive P does not flow over the nozzle part 103.

In the above description, a liquid adhesive, such as ACP, and NCP, is used for the connection of the flexible printed circuit board (PCB) 20 and the inkjet print head chip 100. Alternatively, an anisotropic conductive film (ACF) can be used for the connection of the flexible printed circuit board 20 to the inkjet print head chip 100 according to an example embodiment of the present invention.

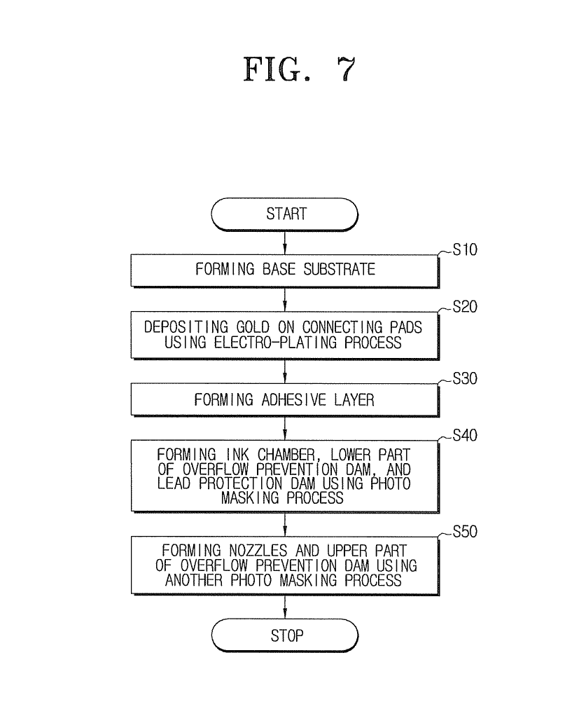

Hereinafter, a manufacturing method of the inkjet print head chip 100 according to an example embodiment of the present invention will be described with reference to FIG. 7.

First, a base substrate (wafer) is provided at block S10. The base substrate is a wafer having electrical circuits formed therein to fire droplets of ink in accordance with an electrical signal and a current from a flexible printed circuit board (PCB) 20, and a plurality of connecting pads formed thereon to be electrically connected with the flexible printed circuit board (PCB) 20 using a conventional semiconductor manufacturing process used to manufacture a conventional inkjet print head chip. In other words, an ink chamber and a plurality of nozzles are not formed on the base substrate. At this time, the plurality of connecting pads is made of a metal, such as aluminum (Al) or aluminum alloy.

Next, according to a photo masking process, spaces through which gold (Au) can be deposited on the plurality of connecting pads are formed on a top surface of the base substrate. Then, gold (Au) is deposited on the metal pad, that is, a plurality of connecting pads, using an electro-plating process at block S20. An adhesive capable of bonding silicon and epoxy is coated on the top surface of the base substrate, and then, patterning is performed, thereby forming an adhesive layer at block S30. Gold (AU) may be selected for its high conductivity and non-reactive metal, while maintaining stable surface. In addition, gold (AU) also has a relatively low melting point, and can easily bond with other substances by heating and pressurization, for example, by TAB bonding. However, the present invention is not limited to gold (AU); rather similar substance, such as silver, copper and aluminum can also be utilized.

Subsequently, a material for forming an ink chamber is uniformly coated on the adhesive layer using, for example, a spin coating, to form a chamber layer. An epoxy type photo-resist may be used as the material for forming the ink chamber.

According to a conventional photo masking process, the ink chamber, a lower part of the overflow prevention dam 110, and the lead protection dam 120 are formed on the base substrate at block S40.

Then, a sacrificial layer is formed on the ink chamber layer, and a material for forming a nozzle is uniformly coated on the sacrificial layer using, for example, a spin coating, to form a nozzle layer. Similarly to the formation of an ink chamber, an epoxy type photo-resist may also be used as the material for forming the nozzle layer.

After that, according to the photo masking process, a plurality of nozzles and an upper part of the overflow prevention dam 110 are formed on the base substrate at block S50.

In other words, in the inkjet print head chip according to an example embodiment of the present invention, the overflow prevention dam and the lead protection dams are formed using ink chamber and nozzle fabricating processes of a conventional inkjet print head chip manufacturing process. As a result, the inkjet print head chip according to an example embodiment of the present invention does not require separate processes for manufacturing the overflow prevention dam and the lead protection dam; rather, the same ink chamber and nozzle fabricating processes of a conventional inkjet print head chip can be advantageously utilized to create an overflow prevention dam and a lead protection dam.

With an inkjet print head chip, a structure for connecting an inkjet print head chip and a flexible printed circuit board (PCB), and a method for connecting an inkjet print head chip and a flexible printed circuit board (PCB) according to an example embodiment of the present invention, a plurality of lead wires of the flexible printed circuit board (PCB) can be connected at once to a plurality of connecting pads of the inkjet print head chip, and an adhesive does not contaminate or block a nozzle part of the inkjet print head chip during the connection process. Therefore, the time for establishing connection between the inkjet print head chip and the flexible printed circuit board (PCB) can be significantly decreased. Furthermore, with a manufacturing method of an inkjet print head chip according to an example embodiment of the present invention, an overflow prevention dam and a lead protection dam can be formed using a conventional inkjet print head chip manufacturing process, not using separate processes. As a result, the manufacture of the inkjet print head chip can be simplified and can be very cost-effective.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, the ink firing portions and corresponding nozzles can be arranged on the nozzle part 103 of the inkjet print head chip 100 in different configurations as long as droplets of ink can be ejected therefrom to form an image on a printable medium. Similarly, the connecting pads 107, as shown in FIGS. 2-4, can also be arranged differently in different order as long as the lead wires 22 of the flexible printed circuit board (PCB) 20 can be matched up to establish electrical connection, when the lead wires 22 of the flexible printed circuit board (PCB) 20 are pressed against the connecting pads 107 of the inkjet print head chip 100. Likewise, both the overflow prevention dam 110 and the lead protection dam 120 can also be arranged differently from that shown in FIGS. 2-4, so long as the overflow of liquid adhesive can be advantageously prevented. More importantly, the inkjet print head chip 100, as shown in FIGS. 2-4, can be provided with a nozzle part 103 and a non-nozzle part (i.e., an electrical connecting part) on which an overflow prevention dam 110 and a lead protection dam 120 are formed, and that the nozzle part 103 can be elevated relative to the non-nozzle part such that the overflow prevention dam 110 and the lead protection dam 120 have the same height relative to the nozzle part 103, and that the gully 112 can be formed between the overflow prevention dam 110 relative to the nozzle part 103. Further, as shown in FIGS. 2-4, the nozzle part 103 can be elevated relative to the non-nozzle part of the base substrate; however, the nozzle part 103 and the non-nozzle part can exhibit the same surface level, and the gully 112 and the region between the overflow prevention dam 110 and the lead protection dam 120 where the plurality of connecting pads 107 is disposed thereon, can be formed by conventional etching processes. Accordingly, it is intended, therefore, that the present invention not be limited to the various example embodiments disclosed, but that the present invention includes all embodiments falling within the scope of the appended claims.

What is claimed is:

1. An inkjet print head chip comprising:
a nozzle part having a plurality of ink firing portions formed therein to fire droplets of ink, via corresponding nozzles respectively, onto a printable medium to form an image;
a plurality of connecting pads disposed adjacent to the nozzle part and electrically connected to the plurality of ink firing portions formed in the nozzle part; and
an overflow prevention dam disposed between the nozzle part and the plurality of connecting pads and to have a height higher than the plurality of connecting pads.

2. The inkjet print head chip of claim 1, wherein the height of the overflow prevention dam is substantially equal to a height of the nozzle part.

3. The inkjet print head chip of claim 1, further comprising;
a lead protection dam formed at a side of the plurality of connecting pads opposite to the overflow prevention dam.

4. A method for manufacturing an inkjet print head chip comprising:
forming a base substrate having a nozzle part in which electrical circuits to fire droplets of ink according to an electrical signal are formed therein and an electrical connecting part in which a plurality of connecting pads is exposed thereon to be electrically connected to corresponding lead wires of a printed circuit board (PCB);
forming a gold (Au) layer on the connecting pads using an electro-plating process;
forming an adhesive layer on the surface of the base substrate;
forming an ink chamber in the nozzle part, a lower part of an overflow prevention dam, and a lead protection dam in the electrical connecting part, using a photo masking process; and
forming a plurality of nozzles extending from the ink chamber in the nozzle part and an upper part of the overflow prevention dam in the electrical connecting part, using another photo masking process.

5. The method of claim 4, wherein the ink chamber, the lower part of the overflow prevention dam, and the lead protection dam are formed using an epoxy type photo-resist.

6. A structure for connecting a flexible printed circuit board to an inkjet print head chip, comprising:
an inkjet print head chip comprising a nozzle part; a plurality of connecting pads disposed at a side of the nozzle part and electrically connected to a plurality of ink firing portions formed in the nozzle part; and an overflow prevention dam disposed between the nozzle part and the plurality of connecting pads and to have a height higher than the plurality of connecting pads;
a flexible printed circuit board provided with a plurality of lead wires corresponding to the plurality of connecting pads one by one; and
an adhesive to bond the plurality of lead wires to the plurality of connecting pads.

7. The structure of claim 6, wherein the adhesive comprises an anisotropic conductive paste (ACP) and a non-conductive paste (NCP).

8. The structure of claim 6, wherein the adhesive comprises an anisotropic conductive film (ACF).

9. The structure of claim 6, wherein the height of the overflow prevention dam is substantially equal to a height of the nozzle part.

10. The structure of claim 6, wherein the inkjet print head chip further comprises a lead protection dam formed at a side of the plurality of connecting pads opposite to the overflow prevention dam.

11. A method for connecting a flexible printed circuit board having a plurality of lead wires to an inkjet print head chip having a nozzle part and a plurality of connecting pads, the method comprising:
coating an adhesive on the plurality of connecting pads of the inkjet print head chip;
positioning the flexible printed circuit board so that the plurality of lead wires of the flexible printed circuit board is aligned with the plurality of connecting pads of the inkjet print head chip;
pressing the plurality of lead wires of the flexible printed circuit board against the plurality of connecting pads of the inkjet print head chip at once using a bonding apparatus;
causing an overflow prevention dam disposed adjacent to the plurality of connecting pads of the inkjet print head chip to block the adhesive pushed out from between the plurality of lead wires and connecting pads, when the plurality of lead wires of the flexible printed circuit board is pressed against the plurality of connecting pads of the inkjet print head chip; and
separating the bonding apparatus from the plurality of lead wires of the flexible printed circuit board.

12. The method of claim 11, wherein, when the adhesive pushed out from between the plurality of lead wires and connecting pads flows over the overflow prevention dam, the adhesive piles up in a gully formed between the overflow prevention dam and the nozzle part.

13. The method of claim 11, wherein the adhesive comprises an anisotropic conductive paste (ACP) and a non-conductive paste (NCP).

14. An inkjet print head chip comprising:
a substrate;
a nozzle part on the substrate, having a plurality of ink firing portions formed therein to fire droplets of ink, via corresponding nozzles respectively, onto a printable medium to form an image;
a plurality of connecting pads formed on the substrate, adjacent to the nozzle part, and electrically connected to the plurality of ink firing portions in the nozzle part; and
an overflow prevention dam formed on the substrate and disposed between the nozzle part and the plurality of connecting pads,
wherein the overflow prevent dam is projected from the substrate so as to prevent an overflow of liquid adhesive, when the liquid adhesive is utilized to bond a plurality of lead wires of a flexible printed circuit board relative to the connecting pads and the plurality of lead wires of the flexible printed circuit board is pressed against the plurality of connecting pads on the substrate.

15. The inkjet print head chip of claim 14, wherein the overflow prevention dam is projected from the substrate so as to have a height substantially equal to a height of the nozzle part.

16. The inkjet print head chip of claim 14, further comprising:
a gully formed between the nozzle part and the overflow prevention dam.

17. The inkjet print head chip of claim 14, further comprising:
a lead protection dam formed at a side of the plurality of connecting pads opposite to the overflow prevention dam, so as to prevent damage to the plurality of lead wires of the flexible printed circuit board.

18. The inkjet print head chip of claim 14, wherein the adhesive comprises an anisotropic conductive paste (ACP) and a non-conductive paste (NCP).

19. The inkjet print head chip of claim 14, wherein the adhesive comprises an anisotropic conductive film (ACF).
